(19) United States
(12) Patent Application Publication
(10) Pub. No.: US 2022/0136235 A1
(43) Pub. Date: May 5, 2022

(54) WALL AND CEILING ACOUSTICAL ISOLATOR

(71) Applicant: MASON INDUSTRIES, INC., HAUPPAUGE, NY (US)

(72) Inventors: DOUGLAS G. VALERIO, SAINT JAMES, NY (US); JAMES R. TAUBY, STONY BROOK, NY (US); JAMES SADLER, SOUND BEACH, NY (US); RAJ H. RAMOTAUR, FARMINGVILLE, NY (US)

(73) Assignee: MASON INDUSTRIES, INC., HAUPPAUGE, NY (US)

(21) Appl. No.: 17/514,721

(22) Filed: Oct. 29, 2021

Related U.S. Application Data
(60) Provisional application No. 63/107,417, filed on Oct. 29, 2020.

(51) Int. Cl. E04B 1/82; F16F 1/373; F16F 15/08

(52) U.S. Cl. CPC E04B 1/8209; F16F 1/3732; F16F 2238/022; E04B 2001/8263; F16F 15/08

(57) ABSTRACT

An acoustical isolating device used to minimize or eliminate noise or vibrations between the walls/ceilings and building structures is contemplated. The contemplated device includes a specially designed/configured steel spring with unique structural elements, cylindrical grommets, and a washer releasably affixed to one of the grommets.

### CROSS-REFERENCE TO RELATED APPLICATIONS AND PRIORITY CLAIMS

This patent application is a Non-Provisional patent application and claims priority under 35 U.S.C. § 119(e) to U.S. Provisional Patent Application Ser. No. 63/107,417, titled “Wall and Ceiling Acoustical Isolator” filed Oct. 29, 2020. The entire disclosure of the aforementioned patent application is incorporated by reference as if fully stated herein.

### FIELD OF THE INVENTION

The present invention is directed to an acoustical isolation mounting device used to attach walls and ceilings to a building structure while minimizing or eliminating noise or vibrations between the walls/ceilings and the building structure. This prevents transmission of aforesaid noise and vibrations to adjacent areas of the building.

### BACKGROUND OF THE INVENTION

Noise and vibrations travel through walls and ceilings in buildings thereby disturbing people in adjacent spaces. Such noise and vibrations are transmitted also through drywall construction, which is ubiquitous in modern day construction. Certain current noise and vibration mitigation devices use components or parts that have a potential for degradation, and of which are also poor isolators. Other current noise and vibration mitigation devices use components or parts that have limited deflection properties, and of which provide a poor response to vibration and sound isolation. Further still, current noise and vibration mitigation devices tend to use components or parts that are time-consuming in installation.

As such, there exists a need for a noise and vibration mitigation device that provides a superior damped response needed for vibration and sound mitigation. There is also a need for a noise and vibration mitigation device that decouples the acoustical and vibratory energy so as to minimize or eliminate aforesaid acoustical and vibratory energy. There is also a need for a noise and vibration mitigation device that is easy to install.

### SUMMARY OF THE INVENTION

An aspect of an embodiment of the present invention contemplates an acoustical isolating device, which may include: a steel spring, where the steel spring may include a flat portion with a central hole, first and second oppositely positioned u-shaped portions, and first and second oppositely positioned slanted (or angled) portions, where the flat portion has a first and a second end and where the oppositely slanted/angled portions are slanted or angled toward the central axis of the central hole of the steel spring. The steel spring or clip retains a furring channel by means of its bent configuration. It also retains an interlocking bushing, which, in one aspect of an embodiment of the present invention may comprise of top and bottom grommets. In an aspect of an embodiment of the present invention, the grommets may be rubber or any similar material. In another aspect of an embodiment of the present invention, the top and bottom grommets may be cylindrical and contiguous in material. In another aspect of an embodiment of the present invention, each of top and bottom grommets may be made of a solid piece of material.

In an aspect of an embodiment of the present invention, the top and bottom cylindrical grommets of the acoustical isolating device may include an interlock surface and a flat surface opposite the interlock surface. In an aspect of an embodiment of the present invention, each of the top and bottom grommets may include an interlock portion which comprises of an extended or protruding semi-circular portion and a semi-circular depression. In an aspect of an embodiment of the present invention, the interlock portion of the top grommet interlocks with the interlock portion of the bottom grommet and are retained within the central hole of the steel spring.

The above-described interlock feature facilitates alignment when the acoustical isolating device is assembled. The flat surface of each grommet provides a bearing surface. The above-described interlock feature also provides acoustical separation between furring channels, attachment hardware and structural support.

In an aspect of an embodiment of the present invention, the acoustical isolating device, may also include a washer releasably affixed to the flat surface of the bottom grommet, where the washer may include a central hole. The washer may be affixed by way of different connecting elements including, without limitation, screws, bolts, nails, etc. The washer, in one aspect of an embodiment of the present invention, provides a load bearing surface against one of the grommets at assembly. The washer, in another aspect of an embodiment of the present invention, provides a fail-safe structure which prevents structural collapse.

In an aspect of an embodiment of the present invention, the first end of the flat portion of the acoustical isolating device may be connected to a first end of the first slanted portion by way of a first parabolic elbow. In another aspect of an embodiment of the present invention, a second end of the first slanted portion of the acoustical isolating device may be connected to the first u-shaped portion by way of a second parabolic elbow.

In an aspect of an embodiment of the present invention, the second end of the flat portion of the acoustical isolating device may be connected to a first end of the second slanted portion by way of a third parabolic elbow. In another aspect of an embodiment of the present invention, a second end of the second slanted portion of the acoustical isolating device may be connected to the second u-shaped portion by way of a fourth parabolic elbow.

In an aspect of an embodiment of the present invention, the flat portion of the steel spring may be parallel with both sides of the first and second u-shaped portions.

In an aspect of an embodiment of the present invention, the top grommet may include a constricted passage connecting an opening at the flat surface of the top grommet with an opening at the interlock portion of the top grommet. In another aspect of an embodiment of the present invention, the bottom grommet may include a constricted passage connecting an opening at the flat surface of the bottom grommet with an opening at the interlock portion of the bottom grommet.

In another aspect of an embodiment of the present invention, the acoustical isolating device may include a screw, where the screw, when screwed through, connects the washer with the top and bottom cylindrical grommets through the central hole of the washer and the constricted passages of each of said top and bottom grommets. The constricted passages provide a tight fit with the screw.

In another aspect of an embodiment of the present invention, the interlock portion of each of the top and bottom cylindrical grommets may be circular and may include a protruding or extended semi-circular portion and a semi-circular depression.

In another aspect of an embodiment of the present invention, each of the protruding semi-circular portion of each of the top and bottom cylindrical grommets may extend from a base which is adjacent said semi-circular depression of each of the top and bottom cylindrical grommets.

In another aspect of an embodiment of the present invention, the protruding semi-circular extension of the top cylindrical grommet interlocks within the semi-circular depression of the bottom cylindrical grommet, while the protruding semi-circular portion of the bottom cylindrical grommet interlocks within the semi-circular depression of the top cylindrical grommet.

Advantages of the contemplated invention include that fact that the bent steel spring or clip in combination with the single attachment screw provides labor savings and improved hat channel retention. This single attachment to the desired structure is a time saver for installers. The low dynamic stiffness exhibited by the grommets provides superior acoustical separation at the attachment point. The two grommets of an aspect of an embodiment of the contemplated invention provide an all-directional cushion around the anchor connected to the structural element. They, in conjunction with the steel spring/clip, provide a superior damped response needed in vibration and sound mitigation.

An aspect of an embodiment of the present invention contemplates use of the acoustical isolating device to attach gypsum walls or used overhead to install gypsum ceilings. An aspect of an embodiment of the present invention contemplates use of the acoustical isolating device at both wall and ceiling partitions. It can also be used to support walls room in room partitions. They can also be used to suspend ceilings in room in room partitions.

In general, the acoustical isolating device as contemplated by an aspect of an embodiment of the present invention, is used to decouple the attachment between walls and the building structure. The steel spring or clip has three bends or parabolic elbows on each side which function to allow the steel spring or clip to deflect and lower the axial stiffness of the mount. In conjunction with the low axial stiffness of the steel spring or clip. The two grommets are designed to interlock with each other and function to keep the steel spring or clip from touching either the wall or the building structure. The two grommets may also be designed to encapsulate the attachment screw which passes through the washers as well as the grommets. This keeps the system in place in case of fire.

The decoupling of the noise and vibration comes from the stiffness of the system/acoustical isolating device. A wall or ceiling system installed without an acoustical mount could have a very stiff system which thus would allow the noise and vibration to pass through the wall/ceilings into adjoining areas. The lower the axial stiffness, the better the noise and vibration decoupling of the system, and therefore the less noise and vibration transmitted to adjoining areas. By using the configuration of the steel spring/clip, the system would be double acting as both the steel spring/clip and the grommets/bushings deflect to lower stiffness of the overall system.

### BRIEF DESCRIPTION OF THE DRAWINGS

FIG. 1 illustrates a perspective view of an acoustical isolating device according to an aspect of an embodiment of the present invention.

FIG. 2 illustrates a front view of an acoustical isolating device according to an aspect of an embodiment of the present invention.

FIG. 3 illustrates a perspective view of a steel spring element of an acoustical isolating device according to an aspect of an embodiment of the present invention.

FIG. 4 illustrates a bottom view of an acoustical isolating device according to an aspect of an embodiment of the present invention.

FIG. 5 illustrates a top view of an acoustical isolating device according to an aspect of an embodiment of the present invention.

FIGS. 6A-6C illustrate perspective cut out, front and rear views of a top cylindrical grommet element of an acoustical isolating device according to an aspect of an embodiment of the present invention.

FIGS. 7A-7C illustrate perspective cut out, front and rear views of a bottom cylindrical grommet element of an acoustical isolating device according to an aspect of an embodiment of the present invention.

FIG. 8 illustrates a side view of a top cylindrical grommet along with a side view of a bottom cylindrical grommet according to an aspect of an embodiment of the present invention.

FIGS. 9A-9B illustrate perspective and side views of a wall installation of an acoustical isolating device according to aspects of embodiments of the present invention.

FIGS. 10A through 10C illustrate test results for a side ceiling installation of an acoustical isolating device according to aspect(s) of embodiment(s) of the present invention.

### A LIST OF THE REFERENCE NUMBERS AND PARTS OF THE INVENTION TO WHICH NUMBERS REFER

100 Acoustical isolating device
102 Steel spring
104 Flat portion of steel spring
104A First end of flat portion of steel spring
104B Second end of flat portion of steel spring
106 Central hole of steel spring
108 First u-shaped portion
108A First end of u-shaped portion
108B Second end of u-shaped portion
110 Second u-shaped portion
110A First end of second u-shaped portion
110B Second end of u-shaped portion
112 First slanted/angled portion
112A First end of first slanted/angled portion
112B Second end of slanted/angled portion
114 Second slanted/angled portion
114A First end of second slanted/angled portion
114B Second end of second slanted/angled portion
116 Top cylindrical grommet
118 Bottom cylindrical grommet
120 Interlock surface of top cylindrical grommet
122 Interlock surface of bottom cylindrical grommet
124 Interlock portion of top cylindrical grommet
126 Interlock portion of bottom cylindrical grommet
128 Flat surface of top cylindrical grommet
130 Flat surface of bottom cylindrical grommet
132 Washer
134 First parabolic elbow/bend
136 Second parabolic elbow/bend
138 Third parabolic elbow/bend
140 Fourth parabolic elbow/bend
142 Constricted passage of top cylindrical grommet
144 Constricted passage of bottom cylindrical grommet
146 Screw
148 Interlock extension of top cylindrical grommet
150 Interlock extension of bottom cylindrical grommet
152 Semi-circular depression of top cylindrical grommet
154 Semi-circular depression of bottom cylindrical grommet
156 Base adjacent semi-circular depression of top cylindrical grommet
158 Base adjacent semi-circular depression of bottom cylindrical grommet
200 Wall installation of acoustical isolating device
202 Steel stud
204 Hat channel
204A Top ridge of hat channel
204B Bottom ridge of hat channel
206 Wall board
208 Screw
300 Ceiling installation of acoustical isolating device

### DETAILED DESCRIPTION OF THE DRAWINGS

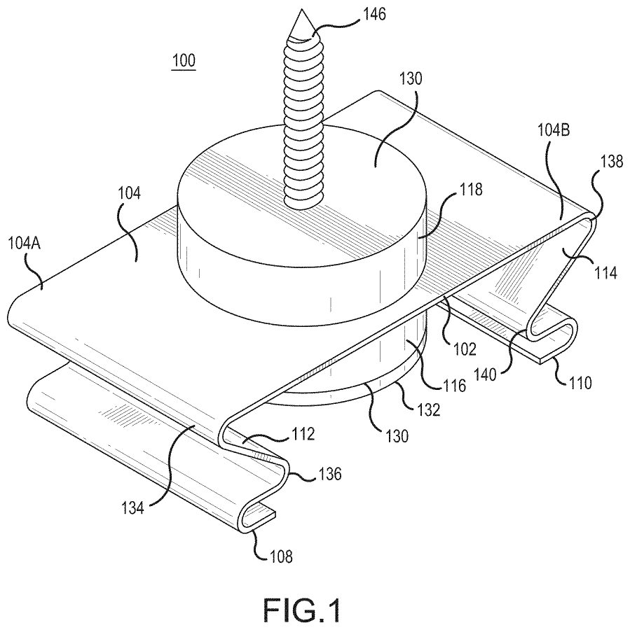

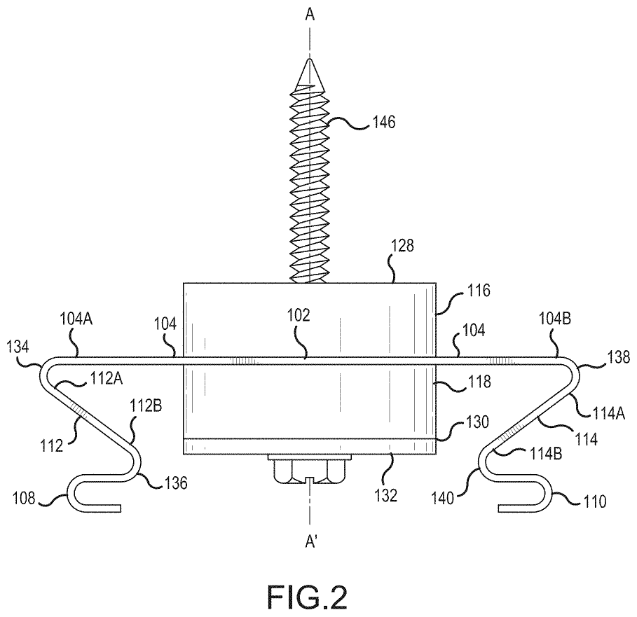

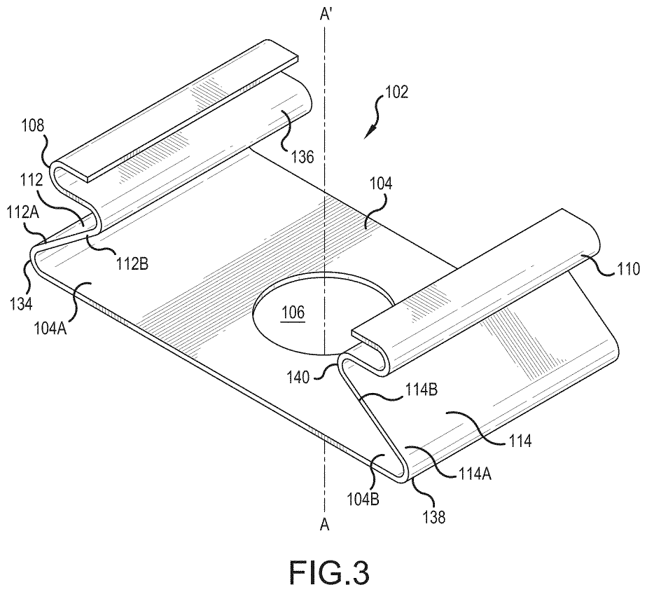

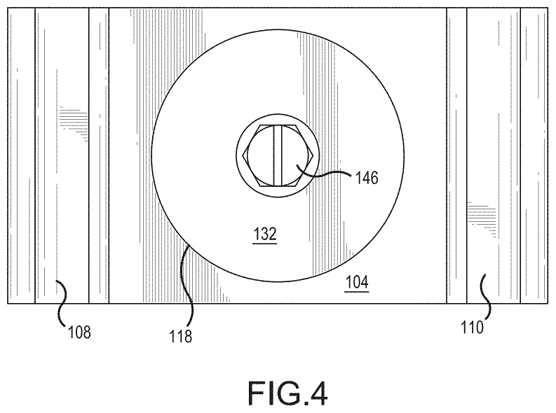

Referring now to FIGS. 1-4, perspective (FIG. 1), front (FIG. 2) and bottom (FIG. 4) views of an acoustical isolating device, 100 along with a perspective view (FIG. 3) of steel spring element 102 of acoustical isolating device 100 are shown according to aspects of embodiments of the present invention. Acoustical isolating device 100 may include steel spring 102, where steel spring 102 may include flat portion 104 with central hole 106. Flat portion 104 of steel spring 102 may include first end 104A and second end 104B with first end 104A connecting with first parabolic elbow 134 and second end 104B connecting with second parabolic elbow 136. First parabolic elbow 134 transitions the connection between first end 104A with first slanted or angled portion 112, where first parabolic elbow 134 connects with first end 112A of first slanted portion 112. A second end 112B of first slanted portion 112 connects with second parabolic elbow 136, which acts as a transitional connection piece between first slanted portion 112 and first u-shaped portion 108.

A third parabolic elbow 138 transitions the connection between second end 104B with second slanted or angled portion 114, where third parabolic elbow 138 connects with first end 114A of second slanted portion 114. A second end 114B of second slanted portion 114 connects with fourth parabolic elbow 140, which acts as a transitional connection piece between second slanted portion 114 and second u-shaped portion 110. In an aspect of an embodiment of the present invention, first slanted portion 112 and second slanted portion 114 of steel spring 102 may be angled toward one another. In another aspect of an embodiment of the present invention, they may be angled toward the axis A-A′ of central hole 106 of steel spring 102. In a further aspect of an embodiment of the present invention, slanted portions 112 and 114 may be angled at 37 degrees from flat portion 104 of steel spring 102.

In an aspect of an embodiment of the present invention, both u-shaped portions 108 and 110 may be oppositely positioned from one another. In another aspect of an embodiment of the present invention, flat portion 104 of the steel spring 102 may be parallel with both sides of first and second u-shaped portions 108 and 110.

Acoustical isolating device 100 may also include top cylindrical grommet 116 and bottom cylindrical grommet 118, where both cylindrical grommets are interlocked with each other within central hole 106. In an aspect of an embodiment of the present invention, may be retained by or within central hole 106. In an aspect of an embodiment of the present invention, top cylindrical grommet 116 and bottom cylindrical grommet 118 may be made of rubber or any similar material. In another aspect of an embodiment of the present invention, the top cylindrical grommet 116 and bottom cylindrical grommet 118 may be contiguous in material. In another aspect of an embodiment of the present invention, each of top cylindrical grommet 116 and bottom cylindrical grommet 118 may be made of a solid piece of material.

Top cylindrical grommet 116 may include a flat surface 128 while bottom cylindrical grommet 118 may also include a flat surface 130. The interlock features of top and bottom grommets 116 and 118 facilitate alignment when assembled. The flat surface of each of top and bottom grommets 116 and 118 provides a bearing surface. The interlock features of top and bottom grommets 116 and 118 also provides acoustical separation between furring channels, attachment hardware and structural support.

Acoustical isolating device 100 may further include washer 132 which may be releasably affixed to flat surface 130 of bottom grommet 118 by screw 146 which threadably connects washer 132, bottom cylindrical grommet 118 (through constricted passage 144 of bottom cylindrical grommet 118, not shown) and top cylindrical grommet 116 (through constricted passage 142 of top cylindrical grommet 116, not shown) along the central axis A-A′ of central hole 106 of steel spring 102. Washer 132, in one aspect of an embodiment of the present invention, provides a load bearing surface against one of the grommets at assembly. Washer 132, in another aspect of an embodiment of the present invention, provides a fail-safe structure which prevents structural collapse. In another aspect of an embodiment of the present invention, washer 132 may be made of steel or any number of materials depending on application.

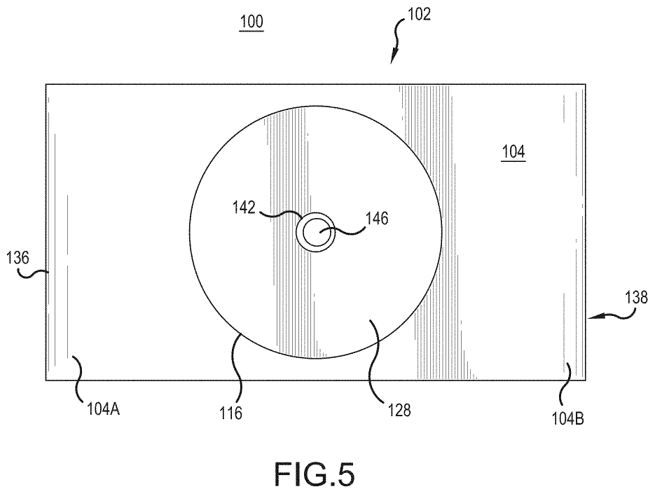

Referring now to FIG. 5 a top view of acoustical isolating device 100 is shown according to an aspect of an embodiment of the present invention. Screw 146 is shown threadably positioned within constricted passage 142 of top cylindrical grommet 116. Top cylindrical grommet 116 is also shown with flat surface 128, while steel spring 102 is shown with flat portion 104 including first end 104A of flat portion 104 connected with first parabolic elbow 136 and second end 104B of flat portion 104 connected with third parabolic elbow 138.

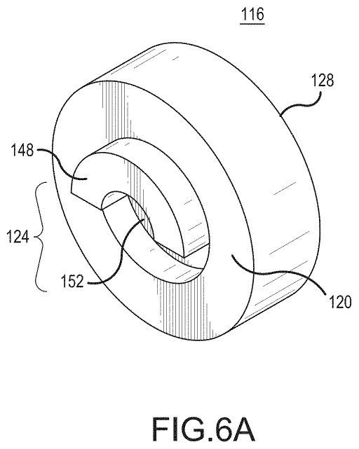

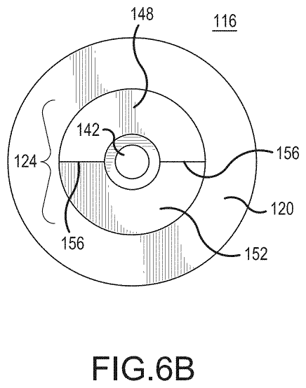

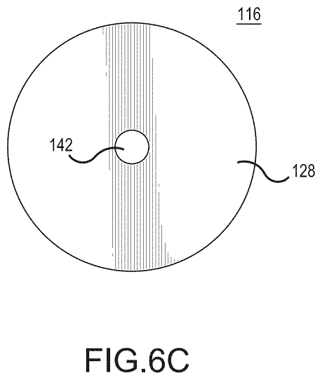

Referring now to FIGS. 6A through 6C, perspective cut out (FIG. 6A), front (FIG. 6B) and rear (FIG. 6C) views of top cylindrical grommet 116 of acoustical isolating device 100 are shown according to aspects of embodiments of the present invention. Top cylindrical grommet 116 is shown including flat surface 128 which is opposite an interlock surface 120. Centrally located within interlock surface 120 is interlock portion 124 which comprises of interlock extension 148 and semi-circular depression 152, where interlock extension 148 is a semi-circular protrusion or extension which extends from a base 156, where, in an aspect of an embodiment of the present invention, base 158 is adjacent semi-circular depression 152. Top cylindrical grommet 116 also includes constricted passage 142 through which screw 146, as shown in FIGS. 1 and 2, threadably connects top cylindrical grommet 116 with bottom cylindrical grommet 118 (not shown). In an aspect of an embodiment of the present invention, constricted passage 142 may be a passage connecting an opening at flat surface 128 with an opening at the center of interlock portion 124.

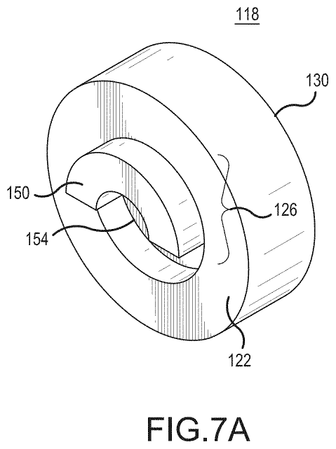

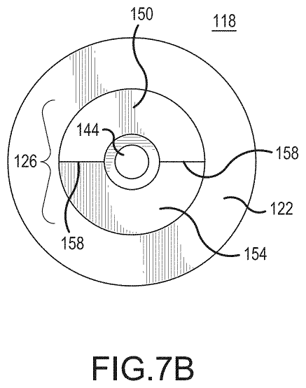

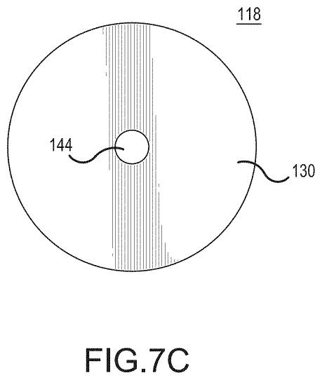

Referring now to FIGS. 7A through 7C, perspective cut out (FIG. 7A), front (FIG. 7B) and rear (FIG. 7C) views of bottom cylindrical grommet 118 of acoustical isolating device 100 are shown according to aspects of embodiments of the present invention. Bottom cylindrical grommet 118 is shown including flat surface 130 which is opposite an interlock surface 122. Centrally located within interlock surface 122 is interlock portion 126 which comprises of interlock extension 150 and semi-circular depression 154, where interface extension 150 is a semi-circular protrusion or extension which extends from a base 158, where, in an aspect of an embodiment of the present invention, base 158 is adjacent semi-circular depression 154. Bottom cylindrical grommet 118 also includes constricted passage 144 through which screw 146, as shown in FIGS. 1 & 2, threadably connects bottom cylindrical grommet 118 with top cylindrical grommet 116. In an aspect of an embodiment of the present invention, constricted passage 144 may be a passage connecting an opening at flat surface 130 with an opening at the center of interlock portion 126.

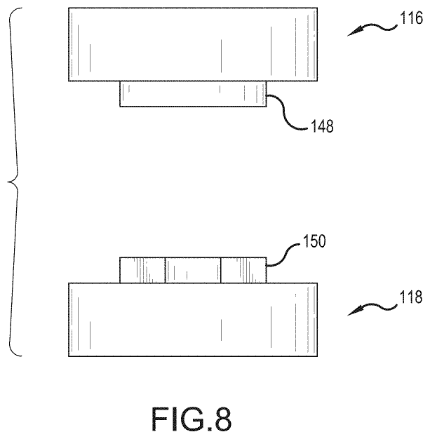

Referring now to FIG. 8, a side view of top cylindrical grommet 116 is shown along with a side view of bottom cylindrical grommet 118 according to an aspect of an embodiment of the present invention. Top cylindrical grommet 116 is shown with interlock extension 148 while bottom cylindrical grommet 118 is shown with interlock extension 150. In an aspect of an embodiment of the present invention, interlock portion 124 of top cylindrical grommet 116 may be complimentary with interlock portion 126 of bottom cylindrical grommet 118 in which both interlock portions interlock with one another within central hole 106 of steel spring 102. In an aspect of an embodiment of the present invention, this may be made possible by interlock extension 148 of top cylindrical grommet 116 interlocking within semi-circular depression 154 of bottom cylindrical grommet 118 and interlock extension 150 of bottom cylindrical grommet 118 interlocking within semi-circular depression 152 of top cylindrical grommet 116.

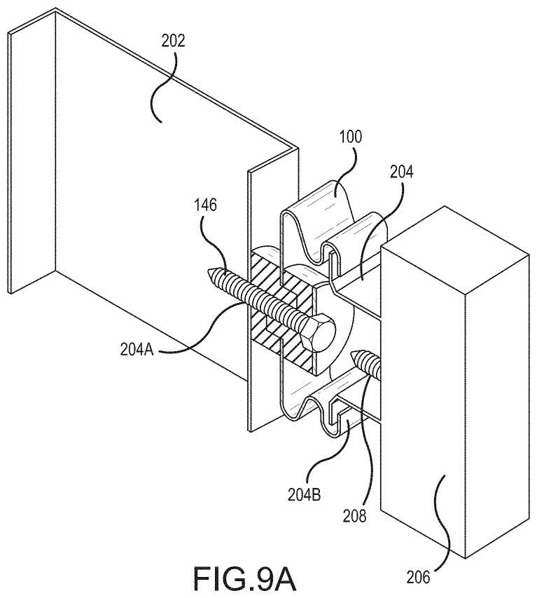

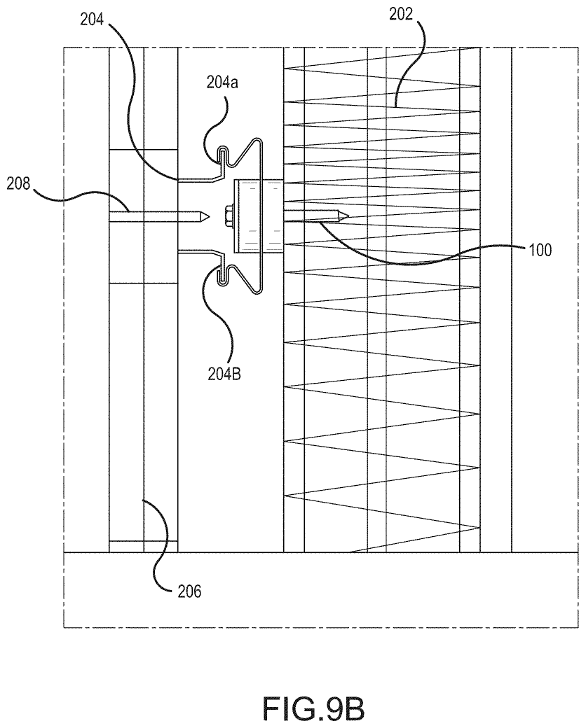

Referring now to FIGS. 9A and 9B perspective and side views of a wall installation 200 of acoustical isolating device 100 is shown according to aspects of embodiments of the present invention. Wall installation 200 is shown with acoustical isolating device 100 attached by way of screw 146 to steel stud 202 of while u-shaped portions 108 and 110 are respectively positioned or sleeved over top and bottom ridges 204A and 204B of hat channel 204. Hat channel 204 is attached to a wall element, such as gypsum wall board 206 by way of screw 208.

The configuration of steel spring or clip 102 in combination with the single attachment screw 146 provides labor savings and improved retention of hat channel 204. This single attachment to the desired structure is a time saver for installers. The low dynamic stiffness exhibited by top and bottom grommets (i.e., bushings) 116 and 118 provides superior acoustical separation at the attachment point. Top and bottom grommets 116 and 118 provide an all-directional cushion around the anchor connected to the structural element (steel stud 202, in this case). Top and bottom grommets 116 and 118, in conjunction with steel spring/clip 102, provide a superior damped response needed in vibration and sound mitigation.

In general, acoustical isolating device 100 as shown and as contemplated by an aspect of an embodiment of the present invention, is used to decouple the attachment between walls and the building structure. Bends or parabolic elbows 134, 136, 138 and 140 of steel spring or clip 102 function to allow steel spring or clip 102 to deflect and lower the axial stiffness of the mount. In conjunction with the low axial stiffness of steel spring or clip 102, top and bottom grommets 116 and 118 are designed to interlock with each other and function to keep steel spring or clip 102 from touching either gypsum wall board 206 or the building structure (i.e., steel stud 202). Top and bottom grommets 116 and 118 may also be designed to encapsulate screw 146 which passes through washer 132 as well as top and bottom grommets 116 and 118. This keeps the system in place in case of fire.

The decoupling of the noise and vibration comes from the stiffness of the system/acoustical isolating device. A wall or ceiling system installed without an acoustical mount could have a very stiff system which thus would allow the noise and vibration to pass through the wall/ceilings into adjoining areas. The lower the axial stiffness, the better the noise and vibration decoupling of the system, and therefore the less noise and vibration transmitted to adjoining areas. By using the configuration of steel spring/clip 102, acoustical isolating device 100 would be double acting as steel spring/clip 102 and top and bottom grommets 116 and 118 deflect to lower stiffness of the overall system.

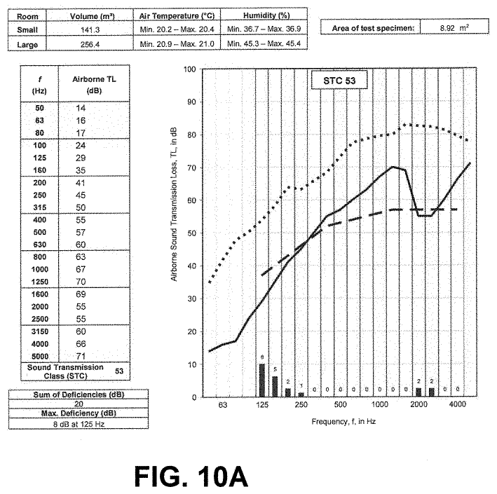

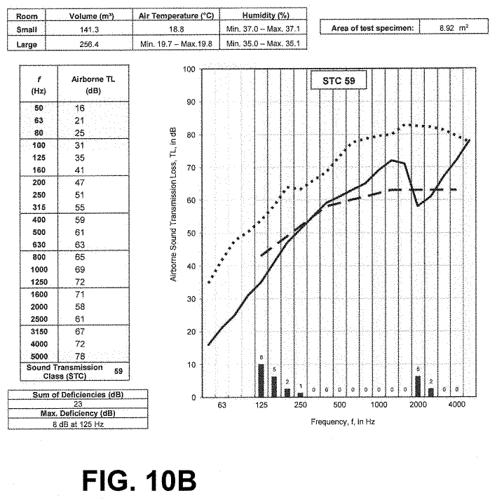

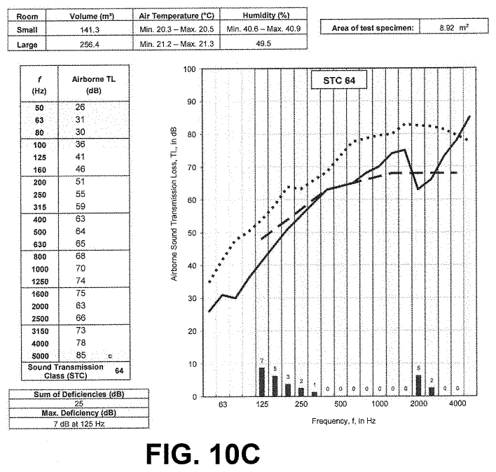

Referring now to FIG. 10A, graphs and tables illustrating test results (ASTM E90 Airborne Sound Transmission Loss tests) of one specimen of acoustical isolating device 100 are shown according to an aspect of an embodiment of the present invention. Here, for this test, acoustical isolating devices 100 were installed within a testing specimen comprising of wall boards 206 (e.g., gypsum boards) on either side of the testing specimen, steel studs and tracks 202 (e.g., 25-gauge steel studs & tracks), hat channels 204 (e.g., 22-gauge furring hat channels; mass/length: 0.4 kg/m), and glass fiber insulation (e.g., R-12 glass fiber insulation; mass/volume: 11.3 kg/m³) for cavities within the testing specimen.

Using FIGS. 9A and 9B as exemplary examples of the testing specimen, a single layer of wall board 206 (e.g., 15.9 mm of Type X gypsum board; mass/area: 10.8 kg/m²) was attached parallel to steel studs 202 using screws 208 spaced in a particular pattern (e.g., 406 mm×610 mm (16″×24″); mass/area: 0.53 kg/m²). Wall board 206 seams were caulked and covered with aluminum tape. Screw heads of screws 208 were covered with aluminum tape. The perimeter was filled with backer rod, caulking and covered with tape.

In an aspect, the single stud wall composed of a wall with an area of 92 mm×2.4 m (3⅝″×96″) with 25-gauge steel studs spaced at 406 mm (16″) apart. Steel studs 202 were fastened to the top and bottom steel track using, for instance, 12.7 mm (½″) pan head screws. The inner-stud wall cavity was filled with 92 mm (3⅝″) R-12 glass fiber insulation.

A number of acoustical isolating devices 100 were fastened to studs 202 using, screws 146 (in one instance, 38 mm (1½″) #10-16 external HEX/slotted self-drilling screws) spaced apart from one another. In one test, a total of 20 acoustical isolating devices 100 were installed. Hat channels 204 (e.g., 22 mm (⅞″) 22 gauge) were mounted horizontally at 610 mm (24″) into acoustical isolating devices 100. A single layer of 15.9 mm (⅝″) Type X gypsum board was installed perpendicular to the furring hat channels 204 using 32 mm (1¼″) #6, scavenger head fine thread drywall screws spaced in a 610 mm×610 mm (24″×24″) pattern. The seams were caulked and taped. Screw heads were covered with aluminum tape. The perimeter was filled with backer rod, caulking and covered with tape. The testing specimen was then tested and the following data in FIG. 10A was generated.

In the graph of FIG. 10A, the solid line is the measured sound transmission loss for a specimen of acoustical isolating device 100. The dashed line is the Sound Transmission Class (STC) contour fitted to the measured values according to ASTM E413-16. The dotted line is the flanking limit established for the facility where the test was conducted. For any frequency band where the measured transmission loss is less than 10 dB lower than the dotted line, the reported value is potentially limited by flanking transmission via laboratory surfaces, and the true value may be higher than that measured. Bars at the bottom of the graph show deficiencies where the measured data are less than the reference contour as described in the fitting procedure for the STC, defined in ASTM E413-16. The shaded cells in the tables and areas in the graph are outside the STC contour range.

Referring now to FIG. 10B, graphs and tables illustrating test results (ASTM E90 Airborne Sound Transmission Loss tests) of another testing specimen including acoustical isolating device 100 are shown according to an aspect of an embodiment of the present invention. Here, for this test, acoustical isolating devices 100 were installed within a testing specimen comprising of wall boards 206 (e.g., gypsum boards) on either side of the testing specimen, steel studs and tracks 202 (e.g., 25-gauge steel studs & tracks), hat channels 204 (e.g., 22-gauge furring hat channels; mass/length: 0.4 kg/m), and glass fiber insulation (e.g., R-12 glass fiber insulation; mass/volume: 11.3 kg/m³) for cavities within the testing specimen.

Using FIGS. 9A and 9B as exemplary examples of the testing specimen, a single layer of wall board 206 (e.g., 15.9 mm of Type X gypsum board; mass/area: 10.8 kg/m²) was attached parallel to steel studs 202 using screws 208 spaced in a particular pattern (e.g., 406 mm×610 mm (16″×24″); mass/area: 0.53 kg/m²). Wall board 206 seams were caulked and covered with aluminum tape. Screw heads of screws 208 were covered with aluminum tape. The perimeter was filled with backer rod, caulking and covered with tape.

In an aspect, the single stud wall composed of a wall with an area of 92 mm×2.4 m (3⅝″×96″) with 25-gauge steel studs spaced at 406 mm (16″) apart. Steel studs 202 were fastened to the top and bottom steel track using, for instance, 12.7 mm (½″) pan head screws. The inner-stud wall cavity was filled with 92 mm (3⅝″) R-12 glass fiber insulation.

A number of acoustical isolating devices 100 were fastened to studs 202 using, screws 146 (in one instance, 38 mm (1½″) #10-16 external HEX/slotted self-drilling screws) spaced apart from one another. In one test, a total of 20 acoustical isolating devices 100 were installed. Hat channels 204 (e.g., 22 mm (⅞″) 22 gauge) were mounted horizontally at 610 mm (24″) into acoustical isolating devices 100. Two layers of 15.9 mm (⅝″) Type X gypsum board were installed for a total thickness of approximately 32 mm. The base layer was installed perpendicular to the furring hat channels 204 using 32 mm (1¼″) #6, scavenger head fine thread drywall screws spaced in a 610 mm×610 mm (24″×24″) pattern. The face layer was installed in the same orientation as the base layer and offset to prevent the seams from overlapping. It was installed with 25.4 mm (1⅝″) #6 scavenger head screws using the same screw spacing as with the base layer. The seams were caulked and taped. Screw heads were covered with aluminum tape. The perimeter was filled with backer rod, caulking and covered with tape. The testing specimen was then tested and the following data in FIG. 10B was generated.

In the graph of FIG. 10B, the solid line is the measured sound transmission loss for a specimen of acoustical isolating device 100. The dashed line is the Sound Transmission Class (STC) contour fitted to the measured values according to ASTM E413-16. The dotted line is the flanking limit established for the facility where the test was conducted. For any frequency band where the measured transmission loss is less than 10 dB lower than the dotted line, the reported value is potentially limited by flanking transmission via laboratory surfaces, and the true value may be higher than that measured. Bars at the bottom of the graph show deficiencies where the measured data are less than the reference contour as described in the fitting procedure for the STC, defined in ASTM E413-16. The shaded cells in the tables and areas in the graph are outside the STC contour range.

Referring now to FIG. 10C, graphs and tables illustrating test results (ASTM E90 Airborne Sound Transmission Loss tests) of a further testing specimen including acoustical isolating device 100 are shown according to an aspect of an embodiment of the present invention. Here, for this test, acoustical isolating devices 100 were installed within a testing specimen comprising of wall boards 206 (e.g., gypsum boards) on either side of the testing specimen, steel studs and tracks 202 (e.g., 25-gauge steel studs & tracks), hat channels 204 (e.g., 22-gauge furring hat channels; mass/length: 0.4 kg/m), and glass fiber insulation (e.g., R-12 glass fiber insulation; mass/volume: 11.3 kg/m³) for cavities within the testing specimen.

Using FIGS. 9A and 9B as exemplary examples of the testing specimen, two layers of wall board 206 (e.g., 15.9 mm of Type X gypsum board; mass/area: 10.8 kg/m²) were installed for a total thickness of approximately 32 m (1¼″). The base layer of the two layers of wall board 206 was attached parallel to steel studs 202 using screws 208 spaced in a particular pattern (e.g., 406 mm×610 mm (16″×24″); mass/area: 0.53 kg/m²). The face layer of the two layers of wall board 206 was installed in the same orientation as with the base layer and offset to prevent the seams from overlapping. It was installed with 25.4 mm (1⅝″) screws using the same screw spacing as with the base layer. The wall board 206 seams were caulked and covered with aluminum tape. Screw heads of screws 208 were covered with aluminum tape. The perimeter was filled with backer rod, caulking and covered with tape.

In an aspect, the single stud wall composed of a wall with an area of 92 mm×2.4 m (3⅝″×96″) with 25-gauge steel studs spaced at 406 mm (16″) apart. Steel studs 202 were fastened to the top and bottom steel track using, for instance, 12.7 mm (½″) pan head screws. The inner-stud wall cavity was filled with 92 mm (3⅝″) R-12 glass fiber insulation.

A number of acoustical isolating devices 100 were fastened to studs 202 using, screws 146 (in one instance, 38 mm (1½″) #10-16 external HEX/slotted self-drilling screws) spaced apart from one another. In this test, a total of 20 acoustical isolating devices 100 were installed. Hat channels 204 (e.g., 22 mm (⅞″) 22 gauge) were mounted horizontally at 610 mm (24″) into acoustical isolating devices 100. Two layers of 15.9 mm (⅝″) Type X gypsum board were installed for a total thickness of approximately 32 mm. The base layer was installed perpendicular to the furring hat channels 204 and fastened using 32 mm (1¼″) #6, scavenger head fine thread drywall screws spaced in a 610 mm×610 mm (24″×24″) pattern. The face layer was installed in the same orientation as the base layer and offset to prevent the seams from overlapping. It was installed with 25.4 mm (1⅝″) #6 scavenger head screws using the same screw spacing as with the base layer. The seams were caulked and taped. Screw heads were covered with aluminum tape. The perimeter was filled with backer rod, caulking and covered with tape. The testing specimen was then tested and the following data in FIG. 10C was generated.

In the graph of FIG. 10C, the solid line is the measured sound transmission loss for a specimen of acoustical isolating device 100. The dashed line is the Sound Transmission Class (STC) contour fitted to the measured values according to ASTM E413-16. The dotted line is the flanking limit established for the facility where the test was conducted. For any frequency band where the measured transmission loss is less than 10 dB lower than the dotted line, the reported value is potentially limited by flanking transmission via laboratory surfaces, and the true value may be higher than that measured. Bars at the bottom of the graph show deficiencies where the measured data are less than the reference contour as described in the fitting procedure for the STC, defined in ASTM E413-16. The shaded cells in the tables and areas in the graph are outside the STC contour range.

Testing Considerations, Significance and Findings

Test Procedure: The testing facility where the tests were conducted comprised of two reverberation rooms identified as “large” and “small” rooms. Airborne sound transmission loss measurements for all tests discussed above were conducted in accordance with the requirements of ASTM E90-09(2016), “Standard Method for Laboratory Measurement of Airborne Sound Transmission Loss of Building Partitions and Elements”. Airborne sound transmission loss tests were performed in the forward (receiving room is the large room) and reverse (receiving room is the small room) directions.

In each case, sound transmission loss values were calculated from the average sound pressure levels of both the source and receiving rooms and the average reverberation times of the receiving room. One-third octave band sound pressure levels were measured for thirty-two seconds at eight microphone positions in each room and then averaged to get the average sound pressure level in each room. Five sound decays were averaged to get the reverberation time at each microphone position in the receiving room; these reverberation times were averaged to get the average reverberation times for each room. Information on the flanking limit of the facility and reference specimen test results are available on request.

Significance of Test Results: ASTM E90-09(2016) requires measurements in one-third octave bands in the frequency range between 100 Hz and 5000 Hz. Within this range, reproducibility was assessed by inter-laboratory round robin studies.

Sound Transmission Class (STC): The Sound Transmission Class (STC) was determined in accordance with ASTM E413-16, “Classification for Rating Sound Insulation.” It is a single-figure rating scheme intended to rate the acoustical performance of a partition element separating offices or dwellings. The higher the value of the STC rating, the better the performance of the building element is expected to be. The rating is intended to correlate with subjective impressions of the sound insulation provided against the sounds of speech, radio, television, music, and similar sources of noise characteristic of offices and dwellings.

Findings: In sum, results of the above testing and operation of acoustical isolating device 100 reveal it to be longer lasting and of the best quality available when compared with prior art devices. The graphical data represent the improvement in STC over standard construction when acoustical isolating device 100 is used. The STC tests verify the improvement over standard non-isolated construction when acoustical isolating device 100 is used.

Although this present invention has been disclosed with reference to specific forms and embodiments, it will be evident that a considerable number of variations may be made without departing from the spirit and scope of the present invention. For example, steps may be reversed, equivalent elements may be substituted for those specifically disclosed and certain features of the present invention may be used independently of other features—all without departing from the present invention as outlined above, in the appended figures and the claims presented below.

What is claimed is:

1. An acoustical isolating device, comprising:
a steel spring, wherein said steel spring comprises of a flat portion with a central hole, first and second oppositely positioned u-shaped portions, first and second oppositely positioned slanted portions, wherein said flat portion has a first end and a second end and wherein said oppositely slanted portions are slanted toward said central hole's axis;
top and bottom cylindrical grommets, wherein each of said top and bottom grommets comprises of an interlock surface and a flat surface opposite said interlock surface, wherein each of said top and bottom grommets each comprises of an interlock portion, wherein the interlock portion of the top grommet interlocks with the interlock portion of the bottom grommet and are retained within the central hole of the steel spring; and
a washer releasably affixed to said flat surface of the bottom grommet, wherein said washer comprises of a central hole.

2. The acoustical isolating device of claim 1, wherein said first end of said flat portion is connected to a first end of said first slanted portion by way of a first parabolic elbow, and wherein a second end of said first slanted portion is connected to said first u-shaped portion by way of a second parabolic elbow.

3. The acoustical isolating device of claim 1, wherein said second end of said flat portion is connected to a first end of said second slanted portion by way of a third parabolic elbow, and wherein a second end of said second slanted portion is connected to said second u-shaped portion by way of a fourth parabolic elbow.

4. The acoustical isolating device of claim 1, wherein the flat portion of the steel spring is parallel with both sides of said first and second u-shaped portions.

5. The acoustical isolating device of claim 1, wherein said top grommet comprises of a constricted passage connecting an opening at said flat surface of said top grommet with an opening at said interlock portion of said top grommet and wherein said bottom grommet comprises of a constricted passage connecting an opening at said flat surface of said bottom grommet with an opening at said interlock portion of said bottom grommet.

6. The acoustical isolating device of claim 5, further comprising of a screw, wherein said screw threadably connects said washer with said top and bottom cylindrical grommets through said central hole of said washer and said constricted passages of each of said top and bottom grommets.

7. The acoustical isolating device of claim 1, wherein said interlock portion of each of said top and bottom cylindrical grommets is circular and comprises of a protruding semi-circular portion and a semi-circular depression.

8. The acoustical isolating device of claim 7, wherein each of said protruding semi-circular portion of each of said top and bottom cylindrical grommets extends from a base which is adjacent said semi-circular depression of each of said top and bottom cylindrical grommets.

9. The acoustical isolating device of claim 7, wherein said protruding semi-circular portion of said top cylindrical grommet interlocks within said semi-circular depression of said bottom cylindrical grommet, and wherein said protruding semi-circular portion of said bottom cylindrical grommet interlocks within said semi-circular depression of said top cylindrical grommet.
